(19) United States
(12) Patent Application Publication
(10) Pub. No.: US 2021/0042271 A1
(43) Pub. Date: Feb. 11, 2021

(54) DISTRIBUTED GARBAGE COLLECTION FOR DEDUPE FILE SYSTEM IN CLOUD STORAGE BUCKET

(71) Applicants: ASHISH GOVIND KHURANGE, Pune (IN); SACHIN BABAN DURGE, Pune (IN); KULDEEP SURESHRAO NAGARKAR, Pune (IN); RAVENDER GOYAL, Saratoga, CA (US)

(72) Inventors: ASHISH GOVIND KHURANGE, Pune (IN); SACHIN BABAN DURGE, Pune (IN); KULDEEP SURESHRAO NAGARKAR, Pune (IN); RAVENDER GOYAL, Saratoga, CA (US)

(21) Appl. No.: 16/532,490

(22) Filed: Aug. 6, 2019

(51) Int. Cl. G06F 16/174; G06F 16/182; G06F 16/16; G06F 12/02

(52) U.S. Cl. CPC G06F 16/1748; G06F 16/1844; G06F 2212/7209; G06F 16/1827; G06F 12/0253; G06F 16/164

(57) ABSTRACT

In one aspect, a computer-implemented method useful for Garbage Collection (GC) for a cloud storage bucket in a dedupe storage network including the step of providing dedupe storage network, wherein the dedupe storage network comprises a many-to-one replication network, a plurality of dedupe file systems that replicate dedupe data to a single storage bucket in a cloud-computing platform. The method includes the step of providing a cloud storage bucket. The cloud storage bucket comprises a set of dedupe chunks replicated from the plurality of dedupe file systems. With a remote GC thread, the method marks a set of expired dedupe images in the cloud storage bucket as expired. With a bucket GC thread, the method removes at least one garbage dedupe chunk from cloud storage bucket.

### CLAIM OF PRIORITY AND CROSS-REFERENCE TO RELATED APPLICATIONS

This application is a continuation in part of and claims priority to U.S. patent application Ser. No. 14/701,530, filed on May 1, 2015 and titled METHODS AND SYSTEMS OF A DEDUPE STORAGE NETWORK FOR IMAGE MANAGEMENT. This application is incorporated herein in its entirety.

### BACKGROUND

### Field of the Invention

This application relates generally to data storage, and more specifically to a system, article of manufacture and method of distributed garbage collection for dedupe file system in cloud storage bucket.

### Description of the Related Art

Various problems exist for Garbage Collection (GC) of dedupe storage in cloud storage bucket. For example, there may not be a compute instance running in the cloud monitoring the bucket storage. Accordingly, a garbage chunk list may not be computable. Additionally, it is noted that a cloud storage bucket has dedupe chunks replicated from many independent dedupe filesystems. Every source dedupe file system has fractional visibility into dedupe file system in cloud storage bucket. Only the part that is replicated by source file system may be visible to that file system. This can create a challenge in doing GC in cloud storage bucket as the storage bucket on itself cannot decide the garbage chunk list. This is because it does not have a compute instance running in the cloud to do the Garbage Collection. Similarly individual dedupe filesystems replicating data to cloud storage bucket can not do the garbage collection as each of the source dedupe file system has fractional view of the dedupe file system in storage bucket. Accordingly, improvements to Garbage Collection (GC) of dedupe storage in cloud storage bucket are desired.

### BRIEF SUMMARY OF THE INVENTION

In one aspect, a computer-implemented method useful for Garbage Collection (GC) for a cloud storage bucket in a dedupe storage network including the step of providing dedupe storage network, wherein the dedupe storage network comprises a many-to-one replication network, a plurality of dedupe file systems that replicate dedupe data to a single storage bucket in a cloud-computing platform. The method includes the step of providing a cloud storage bucket. The cloud storage bucket comprises a set of dedupe chunks replicated from the plurality of dedupe file systems. With a remote GC thread, the method marks a set of expired dedupe images in the cloud storage bucket as expired. With a bucket GC thread, the method removes at least one garbage dedupe chunk from cloud storage bucket.

### BRIEF DESCRIPTION OF THE DRAWINGS

FIG. 1 illustrates an example system of a dedupe storage network, according to some embodiments.

FIG. 2 illustrates an example process for garbage-collection algorithm for a cloud-storage bucket, according to some embodiments.

FIG. 3 illustrates an example process for implementing a remote GC thread, according to some embodiments.

FIG. 4 illustrates an example process for implementing a set of actions upon the start of a remote GC thread, according to some embodiments.

FIG. 5 illustrates an example process for implementing bucket GC, according to some embodiments.

FIG. 6 illustrates an example process for implementing a bucket GC thread, according to some embodiments.

FIG. 7 illustrates an example process for implementing a timestamp with a bucket GC, according to some embodiments.

FIG. 8 depicts an exemplary computing system that can be configured to perform any one of the processes provided herein.

The Figures described above are a representative set, and are not exhaustive with respect to embodying the invention.

### DESCRIPTION

Disclosed are a system, method, and article of manufacture for distributed garbage collection for dedupe file system in cloud storage bucket. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Application server can be, inter alia, a software framework that provides a generalized approach to creating an application-server implementation, regard to what the application functions are and/or the server portion of a specific implementation instance. The server's function can be dedicated to the execution of procedures (e.g. programs, routines, scripts) for supporting its applied applications. An application server can be an example of a physical server.

Backup image (or image) can include copies of programs, system settings, files, etc. It can be a complete system backup that can be used for restore operations.

Chunk (also a data chunk′) can be the segments of data that are generated from a data stream by splitting the data stream at fixed or variable lengths. A chunk can be a specified fixed size or variable size.

Cloud computing can be computing that can involve a large number of computers connected through a communication network such as the Internet. Cloud computing can be a form of distributed computing over a network, and can include the ability to run a program or application on many connected computers at the same time.

Cloud storage bucket is the basic container that holds data in the cloud storage.

Cloud storage can be a model of networked enterprise storage where data is stored in virtualized pools of storage which are generally hosted by third parties. Hosting companies can operate large data centers, and users can have data hosted by leasing storage capacity from said hosting companies. Physically, the resource can span across multiple servers and multiple locations.

Data deduplication can be a technique for reducing the amount of storage space (e.g. eliminating, duplicate copies of data).

Fingerprint can be a small key that uniquely identifies data, a file, etc.

Garbage collection (GC) is a form of automatic memory management. A garbage collector functionality can reclaim garbage/memory occupied by objects that are no longer in use.

Mesh network can be a network topology in which each node relays data for the network. All nodes cooperate in the distribution of data in the network.

Onsite can mean that a dedupe storage node which initiates the replication upload/download.

Replication site can be the dedupe storage node where data is pushed or fetched from. Replication can mean the uploading of the dedupe image to the replication partner.

Additional example definitions are provided herein.

example DEDUPE STORAGE NETWORK FOR IMAGE MANAGEMENT

In some embodiments, a dedupe file system can be implemented for storing and replicating backup images. The dedupe storage network can have to graph topology of one-to-many, many-to-one, and/or many-to-many replication sites. Given any graph topology, it can be converted into a dedupe storage network. For example, the dedupe storage network for dedupe image management can be built using a mesh network topology. The nodes in the graph topology can represent single dedupe store. The edges between these nodes can represent the replication link between two (2) dedupe stores.

If a dedupe chunk is present at any of the dedupe store then none of its various replication partners will replicate the data chunk to the same dedupe store. In this way, band optimizations can be achieved. Replication can be bidirectional. For example, a node can upload images to a replication partner and/or download images from a replication partner. Every dedupe store can have its local file system. All the dedupe images can be stored in the local hard disk (and/or other storage medium) of that particular dedupe store. Each dedupe store can also have a remote file system per replication partner. The remote file system can have the metadata of the dedupe images which have been replicated to the replication partner. The remote file system can also has the database of the data chunks replicated to the replication partner. When an image is expired from a local store, it can then be downloaded from a replication partner.

The dedupe file system can be an inline deduplication file system. The dedupe file system can convert an incoming backup stream to a dedupe image without requiring a staging location. The dedupe file system can store the backup stream by chunk-wise deduplication, compression and/or encryption. Various details of exemplary dedupe file systems are now provided.

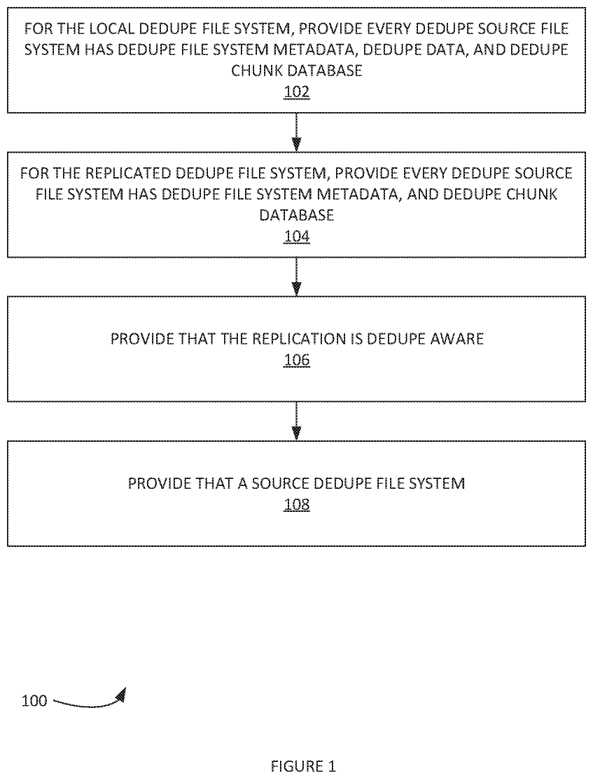

FIG. 1 illustrates an example system 100 of a dedupe storage network, according to some embodiments. In step 102, for the local dedupe file system, process 100 provides that every dedupe source file system has the dedupe file system metadata, the dedupe data, and the dedupe chunk database. In step 104, for the replicated dedupe file system, process 100 provides that every dedupe source file system has the dedupe file system metadata, and the dedupe chunk database.

In step 106, process 100 provides the replication is dedupe aware. For example, every time a file is replicated from source machine to target machine, the dedupe chunks of the file which are not present in the target machine are replicated.

In step 108, process 100 provides a source dedupe file system. The source dedupe file system determines when a dedupe chunk is present or not at the target dedupe file system. This can be done by querying the dedupe chunk database of the replicated file system for the target.

Example Methods

In an example dedupe storage network configuration, a many-to-one replication network is provided. In a many-to-one replication network, a plurality of dedupe file systems can replicate dedupe data to a single storage bucket in a cloud-computing platform. It is noted that a GC algorithm for the cloud storage bucket is implemented in two phases.

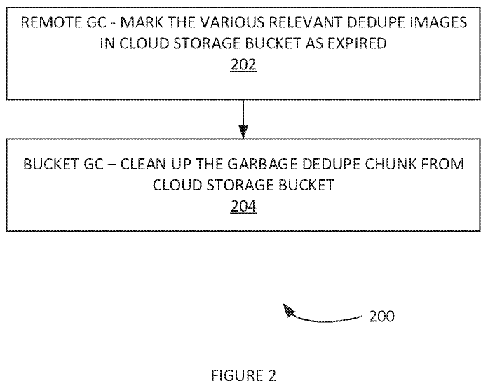

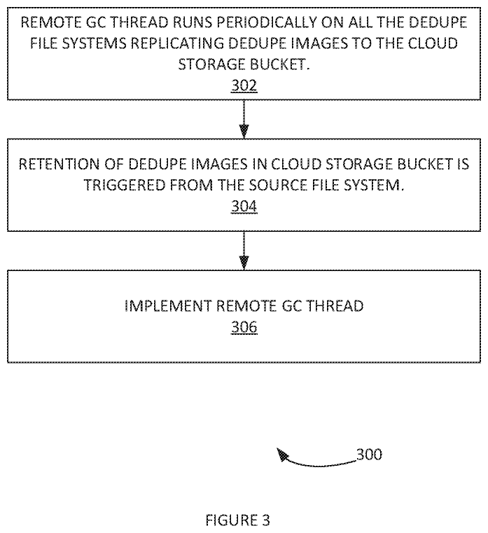

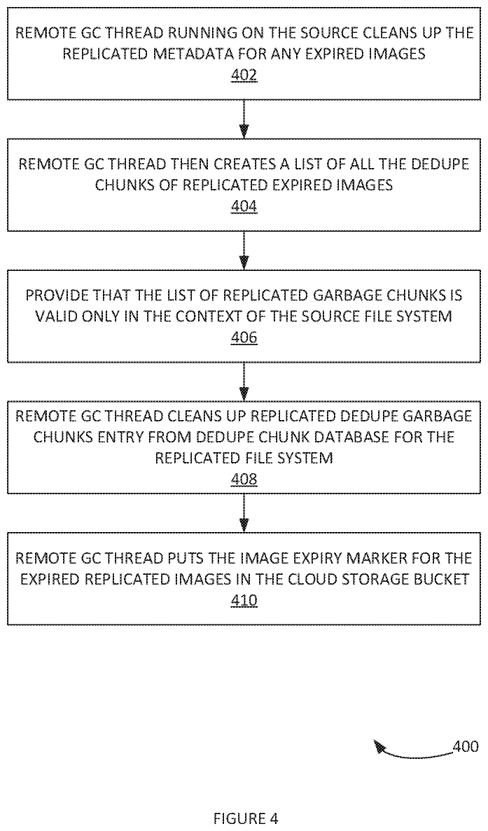

FIG. 2 illustrates an example process 200 for garbage-collection algorithm for a cloud-storage bucket, according to some embodiments. Process 200 for a GC algorithm for cloud storage bucket can be implemented in two phases. In step 202, process 200 can implement Remote GC. In step 202, process 200 can mark the various relevant dedupe images in cloud storage bucket as expired. All the source file system is replicated as deduped data to a cloud storage bucket. Process 200 runs the remote GC. The remote GC cleans up the source file system's view of replicated data by cleaning up dedupe chunk database for the replicated file system. Process 200 puts the expiry marker for expired images in the cloud storage bucket. More specific aspects of process 200 are provided in FIG. 3 and FIG. 4 infra.

FIG. 3 illustrates an example process 300 for implementing a remote GC thread, according to some embodiments. In step 302, a remote GC thread runs periodically on all the dedupe file systems. In step 304, the retention of dedupe images in the cloud storage bucket is triggered from the source file system. In step 306, when the remote GC thread starts it performs a specified set actions (e.g. see FIG. 4 infra).

FIG. 4 illustrates an example process 400 for implementing a set of actions upon the start of a remote GC thread, according to some embodiments. In step 402, the remote GC thread running on the source cleans up the replicated metadata for any expired replicated images. It is noted that, for every replicated dedupe image, the respective image source maintains the replicated metadata.

In step 404, the remote GC thread then creates a list of all the dedupe chunks of replicated expired images. Then, for each of the valid replicated images, process 400 filters their dedupe chunks out from the list. In this way, at the end of step 404, the list contains the list of replicated garbage chunks.

In step 406, process 400 provides that the list of replicated garbage chunks is valid only in the context of the source file system. For example, in the context of the dedupe file system in cloud storage bucket this list is not valid. This is due to the issue that there may be several other dedupe file systems replicating to the same cloud storage bucket, and a source dedupe file system(s) may have a valid dedupe image referring to a dedupe chunk in this list of replicated garbage chunks. As a result, any source dedupe file system cannot clean up replicated dedupe garbage chunks from the cloud storage bucket.

In step 408, the remote GC thread cleans up the replicated dedupe garbage chunks entry from the dedupe chunk database for the replicated file system. In this way, the source file system cleans up its view of the replicated file system in the cloud storage bucket.

In step 410, the remote GC thread puts the image expiry marker for the expired replicated images in the cloud storage bucket. By putting the expiry marker in this way, process 400 can inform a consumer of the cloud storage bucket that the corresponding dedupe images are expired.

Returning to process 200, in step 204, process 200 can implement a bucket GC. In step 204, process 200 can clean up the garbage dedupe chunk from cloud storage bucket. Step 204 involves the cleaning of expired dedupe chunks in the cloud storage bucket.

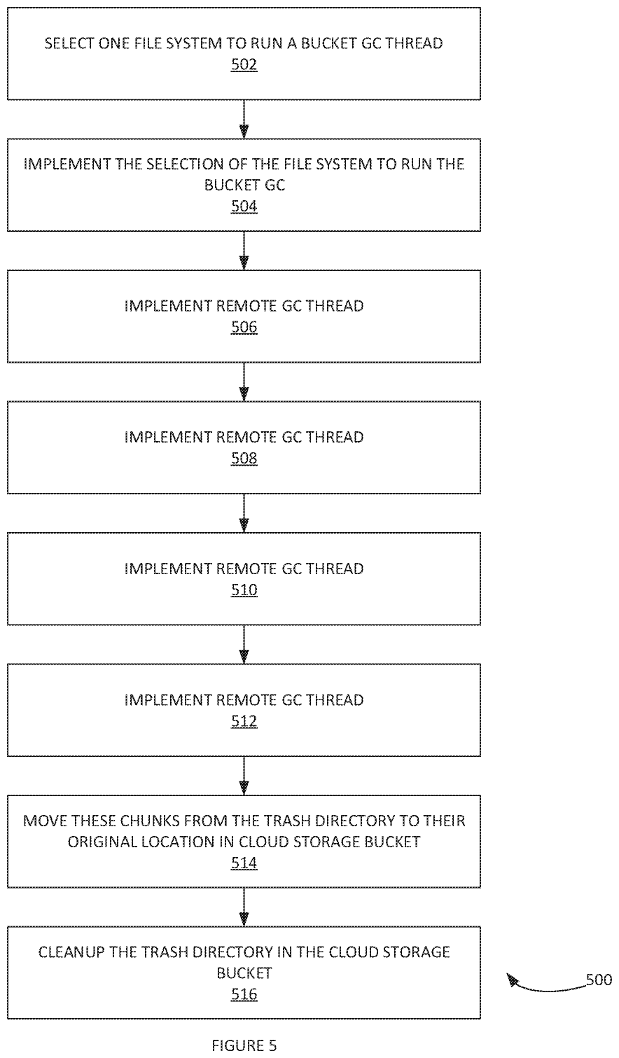

FIG. 5 illustrates an example process 500 for implementing bucket GC, according to some embodiments. In step 502, from the source file systems replicating to the cloud storage bucket, process 500 selects only one file system to run the Bucket GC thread.

In step 504, process 500 implements the selection of the file system to run the Bucket GC. The selection can be static or dynamic. In the case of a dynamic selection, process 500 can use the distributed leader selection algorithm to select the source file system to run the Bucket GC.

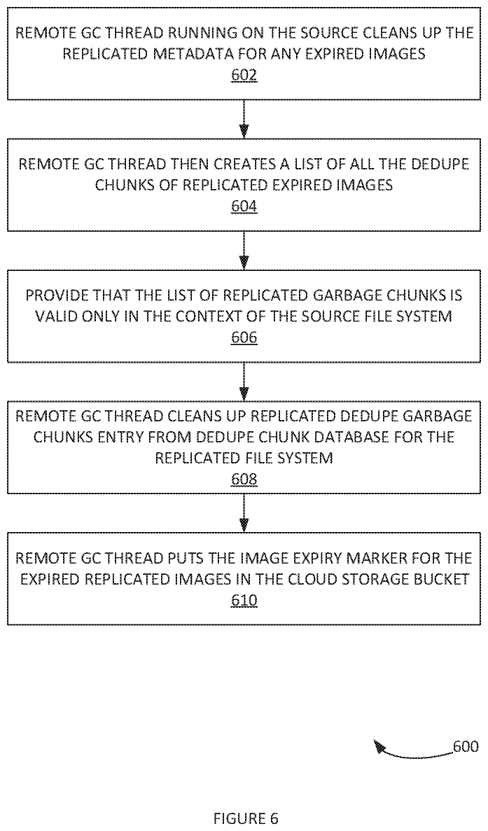

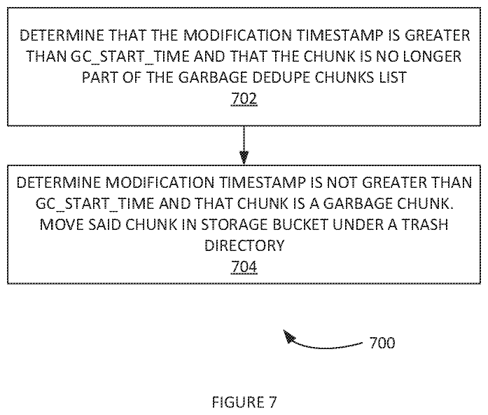

In step 506, a bucket GC thread is implemented. In one example, step 506 can be implemented with the processes of FIG. 6 and FIG. 7.

FIG. 6 illustrates an example process 600 for implementing a bucket GC thread, according to some embodiments. In step 602, before starting operation, a Bucket GC thread marks current time as GC_START_TIME. In step 604, process 600 downloads the entire dedupe metadata from the cloud storage bucket. This provides the Bucket GC a holistic view of the dedupe file system in cloud storage bucket as it contains metadata from all the replicating source file systems.

In step 606, from this holistic metadata, the bucket GC computes the actual list of garbage dedupe chunks for the cloud storage bucket. In step 608, for each of the dedupe chunks in the garbage dedupe chunks list, the relevant modification timestamp is matched with the GC_START_TIME.

FIG. 7 illustrates an example process 700 for implementing a timestamp with a bucket GC, according to some embodiments. In step 702, process 700 determines if the modification timestamp is greater than GC_START_TIME. If it is, it means that while the bucket GC was computing the garbage dedupe chunks list, any of the replicating source file system had uploaded the same chunk to the cloud storage bucket giving it a new life. Process 700 determines that the chunk is now no longer part of the garbage dedupe chunks list.

In step 704, if the modification timestamp is not greater than GC_START_TIME, that chunk is determined to be a garbage chunk. Process 700 moves said chunk in storage bucket under a trash directory.

Returning to process 500, in step 508, all the garbage dedupe chunks are moved to the trash directory in the cloud storage bucket. In step 510, the bucket GC thread again downloads the dedupe metadata from the cloud storage bucket.

In step 512, the bucket GC thread locates the list of all the dedupe images replicated to cloud storage bucket. The list has metadata with timestamp greater than GC_START_TIME. This is a list of dedupe images which were replicated to the cloud storage bucket after the bucket GC started the operation.

In step 514, the bucket GC thread locates the list of all the dedupe images replicated to cloud storage bucket after the bucket GC started. For each of the dedupe chunk of newly replicated dedupe image check, process 500 determines if these are present in the trash directory in the cloud storage bucket. If it is present in the trash directory then process 500 determines that it is no longer a garbage chunk as newly replicated dedupe image is referring to it. For all such dedupe chunks in trash directory, process 500 moves these chunks from the trash directory to their original location in cloud storage bucket.

In step 516, all the chunks in the trash directory are determined to be garbage chunks. Process 500 cleanups the trash directory in the cloud storage bucket. In this way, the bucket GC reclaims the space by deleting the garbage dedupe chunks from cloud storage bucket.

Exemplary Computer Architecture and Systems

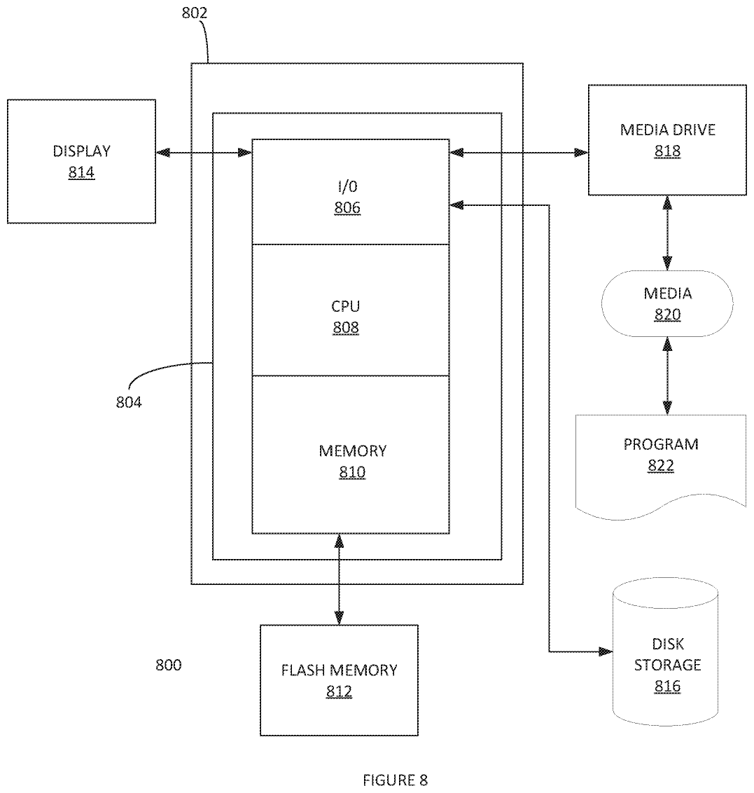

FIG. 8 depicts an exemplary computing system 800 that can be configured to perform any one of the processes provided herein. In this context, computing system 800 may include, for example, a processor, memory, storage, and I/O devices (e.g., monitor, keyboard, disk drive, Internet connection, etc.). However, computing system 800 may include circuitry or other specialized hardware for carrying out some or all aspects of the processes. In some operational settings, computing system 800 may be configured as a system that includes one or more units, each of which is configured to carry out some aspects of the processes either in software, hardware, or some combination thereof.

FIG. 8 depicts computing system 800 with a number of components that may be used to perform any of the processes described herein. The main system 802 includes a motherboard 804 having an I/O section 806, one or more central processing units (CPU) 808, and a memory section 810, which may have a flash memory card 812 related to it. The I/O section 806 can be connected to a display 814, a keyboard and/or other user input (not shown), a disk storage unit 816, and a media drive unit 818. The media drive unit 818 can read/write a computer-readable medium 820, which can contain programs 822 and/or data. Computing system 800 can include a web browser. Moreover, it is noted that computing system 800 can be configured to include additional systems in order to fulfill various functionalities. Computing system 800 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computer-implemented method useful for Garbage Collection (GC) for a cloud storage bucket in a dedupe storage network comprising:
providing dedupe storage network, wherein the dedupe storage network comprises a many-to-one replication network, a plurality of dedupe file systems that replicate dedupe data to a single storage bucket in a cloud-computing platform;
providing a cloud storage bucket, wherein the cloud storage bucket comprises a set of dedupe chunks replicated from the plurality of dedupe file systems;
with a remote GC thread, marking a set of expired dedupe images in the cloud storage bucket as expired; and
with a bucket GC thread, removing at least one garbage dedupe chunk from cloud storage bucket.

2. The computer-implemented method of claim 1, wherein the remote GC thread runs periodically on the set of dedupe file systems.

3. The computer-implemented method of claim 2, wherein a retention of the set of dedupe images in the cloud storage bucket is triggered from the source file system.

4. The computer-implemented method of claim 3, wherein the remote GC thread runs on the source file system and cleans up any replicated metadata for the set of expired dedupe images.

5. The computer-implemented method of claim 4, wherein for a replicated dedupe image, a respective image source maintains the replicated metadata.

6. The computer-implemented method of claim 5 further comprising:
determining that a list of replicated garbage chunks is valid only in the context of the source file system.

7. The computer-implemented method of claim 6, wherein the remote GC thread cleans up a replicated dedupe garbage chunks entry from a dedupe chunk database for the replicated file system.

8. The computer-implemented method of claim 7, wherein the remote GC thread puts an image expiry marker for a set of expired replicated images in the cloud storage bucket.

9. The computer-implemented method of claim 8 further comprising:
from a plurality of source file systems replicating to the cloud storage bucket, selecting a single file system to run the Bucket GC thread.

10. The computer-implemented method of claim 9, wherein the bucket GC thread locates the list of the dedupe images replicated to cloud storage bucket. Bucket GC finds out list of garbage chunks and moves it to the trash directory inside the cloud storage bucket.

11. The computer-implemented method of claim 10, wherein the bucket GC thread locates the list of the dedupe images replicated to cloud storage bucket after bucket GC started operation, such that all the chunks referred by newly created dedupe images are not garbage and are moved from the trash directory to original location in cloud storage bucket.

12. The computer-implemented method of claim 11, wherein all the chunks in a trash directory are determined to be garbage chunks.

13. The computer-implemented method of claim 12, wherein the trash directory in the cloud storage bucket is deleted.
